(19) United States
(12) Patent Application Publication
(10) Pub. No.: US 2024/0067858 A1
(43) Pub. Date: Feb. 29, 2024

(54) ALIPHATIC EPOXY RESIN CROSSLINKED POLYMERS FOR PRIMARY CEMENTING IN A BOREHOLE

(71) Applicant: Saudi Arabian Oil Company, Dhahran (SA)

(72) Inventors: Abdullah Saleh Hussain Al-Yami, Dhahran (SA); Ali Mohammed Hussain Al Safran, Dhahran (SA); Vikrant Wagle, Abqaiq (SA); Ali Al-Shaikh, Al-Hufuf (SA); Essam Mohamed, Al Khobar (SA); Julio C. Guzman Munoz, Dhahran (SA)

(21) Appl. No.: 17/898,848

(22) Filed: Aug. 30, 2022

(51) Int. Cl. C09K 8/44; C04B 22/06; C04B 22/14; C04B 24/12; C04B 26/14

(52) U.S. Cl. CPC C09K 8/44; C04B 22/06; C04B 22/142; C04B 24/121; C04B 26/14

(57) ABSTRACT

The disclosure relates to systems and methods in which aliphatic epoxy resin crosslinked polymers are used in primary cementing applications. The aliphatic epoxy resin crosslinked polymers contain a derivative of a first epoxy resin, a derivative of a second epoxy resin and a polyamine. The first epoxy resin contains bisphenol A and an aliphatic monoglycidyl ether. The second epoxy resin contains a C₁₂-C₁₄ alkyl glycidyl ether.

### FIELD

The disclosure relates to systems and methods in which aliphatic epoxy resin crosslinked polymers are used in primary cementing applications. The aliphatic epoxy resin crosslinked polymers contain a derivative of a first epoxy resin, a derivative of a second epoxy resin and a polyamine. The first epoxy resin contains bisphenol A and an aliphatic monoglycidyl ether. The second epoxy resin contains a C₁₂-C₁₄ alkyl glycidyl ether.

### BACKGROUND

Low-density cement slurries can be used to reduce the hydrostatic pressure on weak formations and to cement lost circulation zones. Examples of low-density cements are water extender cements, foam cements and hollow microsphere (ceramic and glass) cements.

Water extender cements are limited in density to nearly 86 pcf. Cement fall-back often occurs because the formations cannot withstand the hydrostatic load from the water extender cements. Sulfide containing water can then corrode the uncemented casing. Water extender cements can be used in multistage operations; however, multistage cementing is limited in its success. Stage tools can fail resulting in remedial operations such as perforation and squeeze jobs. In addition, stage tools are considered a weak point and may not provide a long-term seal.

Hollow glass or ceramic microspheres can be mixed with cement to reduce cement density. Hollow microsphere cement can be used to prepare cement with a density of 69 pound-force per cubic foot (pcf). Gas can be added to the microspheres to reduce cement density to 60 pcf. Another method to utilize hollow microsphere is to mix them with a plasticizer, cement and a strengthening agent such as aluminum metal powder and sodium sulfate. An additional method of preparing low-density cement includes preparing a mixture of coarse and fine cement particles, fly ash, fumed silica, hollow microspheres and water.

### SUMMARY

The disclosure relates to systems and methods in which aliphatic epoxy resin crosslinked polymers are used in primary cementing applications. The aliphatic epoxy resin crosslinked polymers contain a derivative of a first epoxy resin, a derivative of a second epoxy resin and a polyamine. The first epoxy resin contains bisphenol A and an aliphatic monoglycidyl ether. The second epoxy resin contains a C₁₂-C₁₄ alkyl glycidyl ether.

The systems and methods can be used to cement casings in weak formations and/or in horizontal applications to improve wellbore integrity. The systems and methods can reduce damage to formations and cement fallback as the systems and methods can have a reduced hydrostatic pressure on the formation relative to other cementing compositions. The systems and methods can also reduce (e.g., prevent) corrosion of casings by preventing a corrosive fluid (e.g., sulfide containing water) from contacting the casings. The systems and methods can be implemented relatively easily and inexpensively without the need for multistage operations and stage tools. The systems and methods can be suitable for providing a long-term seal.

The aliphatic epoxy resin crosslinked polymers can have a variable density, including a relatively low density compared to that of other cementing compositions. The aliphatic epoxy resin crosslinked polymers can also have a controlled thickening time and a high compressive strength relative to that of other cementing compositions.

In a first aspect, the disclosure provides a method, including adding a mixture including a first epoxy resin, a second epoxy resin and a polyamine to an annular space formed by a casing and a borehole. The mixture forms epoxy resin crosslinked polymers including a derivative of the first epoxy resin, a derivative of the second epoxy resin and the polyamine in the annular space. The first epoxy resin includes bisphenol A and an aliphatic monoglycidyl ether and the second epoxy resin includes a C₁₂-C₁₄ alkyl glycidyl ether.

In some embodiments, the polyamine includes a diethylenetriamine, tetraethylenepentamine, a linear derivative of diethylenetriamine, a branched derivative of diethylenetriamine, and/or a derivative of diethylenetriamine inclduing at least one ring.

In some embodiments, the polyamine includes diethylenetriamine, tetraethylenepentamine, N¹,N¹′-(ethane-1,2-diyl)bis(N²-(2-aminoethyl)ethane-1,2-diamine), N¹-(2-aminoethyl)-N²-(2-((2-((2-((2-aminoethyl)amino)ethyl)amino)ethyl)amino)ethyl)ethane-1,2-diamine, N¹,N¹,N²-tris(2-aminoethyl)ethane-1,2-diamine, N¹-(2-(4-(2-aminoethyl)piperazin-1-yl)ethyl)ethane-1,2-diamine, and/or N¹-(2-aminoethyl)-N²-(2-(piperazin-1-yl)ethyl)ethane-1,2-diamine.

In some embodiments, the mixture includes a weight percent (w.t. %) of the first epoxy resin of 76 w.t. % to 83 w.t. %.

In some embodiments, the mixture includes a weight percent of the second epoxy resin of 12 w.t. % to 20 w.t. %.

In some embodiments, the mixture includes a weight percent of the polyamine of 2 w.t. % to 3 w.t. %.

In some embodiments, the mixture and the epoxy resin crosslinked polymers further include manganese tetroxide and/or barite.

In some embodiments, the mixture includes a weight percent of manganese tetroxide of 1 w.t. % to 5 w.t. %.

In some embodiments, a thickening time of the mixture is from 3.5 hours to 8.5 hours.

In some embodiments, the epoxy resin crosslinked polymers have a density of 62.5 pcf to 68 pcf.

In some embodiments, the resin epoxy resin crosslinked polymers have a compressive strength of 1,000 pound-force (lbf) to 20,000 lbf.

In some embodiments, the epoxy resin crosslinked polymers have a consistency of from 12 Bc. to 100 Bc. after a time of at least 8.5 hours after forming the mixture.

In some embodiments, the mixture is substantially free of water.

In some embodiments, the mixture is used in a primary cementing application.

In a second aspect, the disclosure provides a system including an annular space formed by a casing and a borehole, and epoxy resin crosslinked polymers occupying at least a portion of the annular space formed by the casing and the borehole. The epoxy resin crosslinked polymers include a derivative of a first epoxy resin, a derivative of a second epoxy resin and a polyamine in the annular space, the first epoxy resin includes bisphenol A and an aliphatic monoglycidyl ether, and the second epoxy resin includes a C₁₂-C₁₄ alkyl glycidyl ether.

In certain embodiments, the polyamine includes diethylenetriamine, tetraethylenepentamine, a linear derivative of diethylenetriamine, a branched derivative of diethylenetriamine, and/or a derivative of diethylenetriamine that includes at least one ring.

In certain embodiments, the polyamine includes diethylenetriamine, tetraethylenepentamine, N¹,N¹′-(ethane-1,2-diyl)bis(N²-(2-aminoethyl)ethane-1,2-diamine), N¹-(2-aminoethyl)-N²-(2-((2-((2-((2-aminoethyl)amino)ethyl)amino)ethyl)amino)ethyl)ethane-1,2-diamine, N¹,N¹,N²-tris(2-aminoethyl)ethane-1,2-diamine, N¹-(2-(4-(2-aminoethyl)piperazin-1-yl)ethyl)ethane-1,2-diamine, and/or N¹-(2-aminoethyl)-N²-(2-(piperazin-1-yl)ethyl)ethane-1,2-diamine.

In certain embodiments, the epoxy resin crosslinked polymers further include manganese tetroxide and/or barite.

In certain embodiments, the epoxy resin crosslinked polymers have a density of 62.5 pcf to 68 pcf.

In certain embodiments, the epoxy resin crosslinked polymers have a compressive strength of 1,000 lbf to 20,000 lbf.

### BRIEF DESCRIPTION OF THE FIGURES

FIGS. 1a and b are schematic illustrations of a system.

FIG. 2 is a chemical structure.

FIG. 3 is a chemical structure.

FIGS. 4a and 4b are a series of chemical structures.

FIG. 5a is a graph of consistency over time.

FIG. 5b is an illustration of a formulation.

FIG. 6a is a graph of consistency over time.

FIG. 6b is an illustration of a formulation.

FIG. 7a is a graph of consistency over time.

FIG. 7b is an illustration of a formulation.

FIG. 8a is a graph of consistency over time.

FIGS. 8b and 8c are photographs of a formulation.

FIG. 9a is a graph of consistency over time.

FIGS. 9b and 9c are illustrations of a formulation.

FIG. 10a is a graph of consistency over time.

FIG. 10b is an illustration of a formulation.

FIGS. 11a and 11b are graphs of load applied.

FIGS. 12a and 12b are graphs of load applied.

FIGS. 13a and 13b are graphs of load applied.

FIG. 14 is an illustration of a formulation.

### DETAILED DESCRIPTION

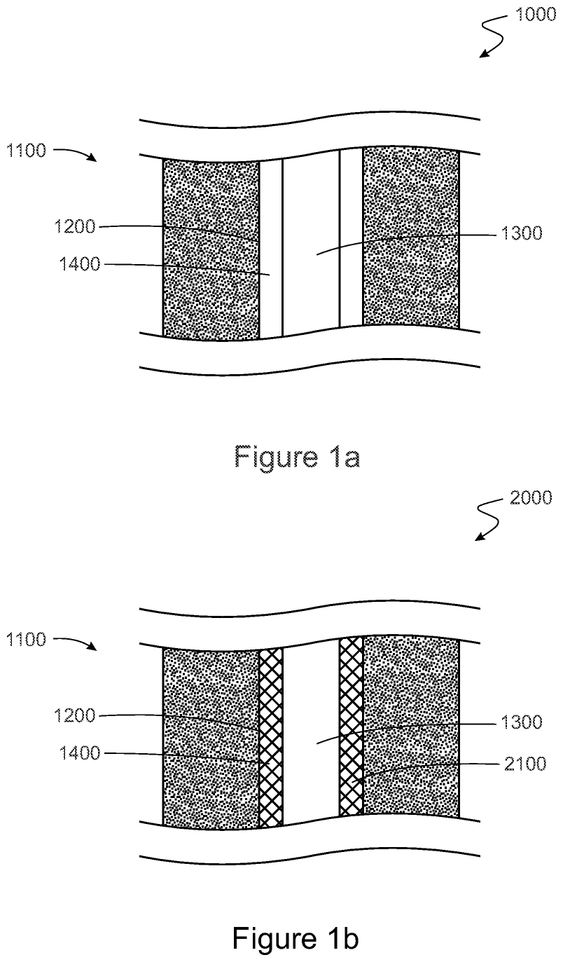

FIG. 1a schematically depicts a system 1000 that includes an underground formation 1100 with a borehole 1200. Within the borehole is a casing 1300. An annular space 1400 is formed between the space between the inner surface of the borehole 1200 and the outer surface of the casing 1300.

FIG. 1b schematically depicts a system 2000 with corresponding components as in the system 1000 shown in FIG. 1. However, unlike the system 1000, the system 2000 includes aliphatic epoxy resin crosslinked polymers 2100 disposed in the annular space 1400 formed by the borehole 1200 and the casing 1300. The aliphatic epoxy resin crosslinked polymers 2100 can cement the casing 1300 in the borehole 1200.

The aliphatic epoxy resin crosslinked polymers 2100 can be formed from a mixture containing a first epoxy resin (e.g., bisphenol A and an aliphatic monoglycidyl ether), a second epoxy resin (e.g., C₁₂-C₁₄ alkyl glycidyl ether) and a polyamine. Generally, the first epoxy resin contains an aromatic group (e.g., bisphenol A) and a glycidyl ether and the second epoxy resin contains an alkyl group (e.g., C₁₂-C₁₄ alkyl) and a glycidyl ether. The aliphatic epoxy resin crosslinked polymers 2100 contain a derivative of a first epoxy resin, a derivative of a second epoxy resin and a polyamine.

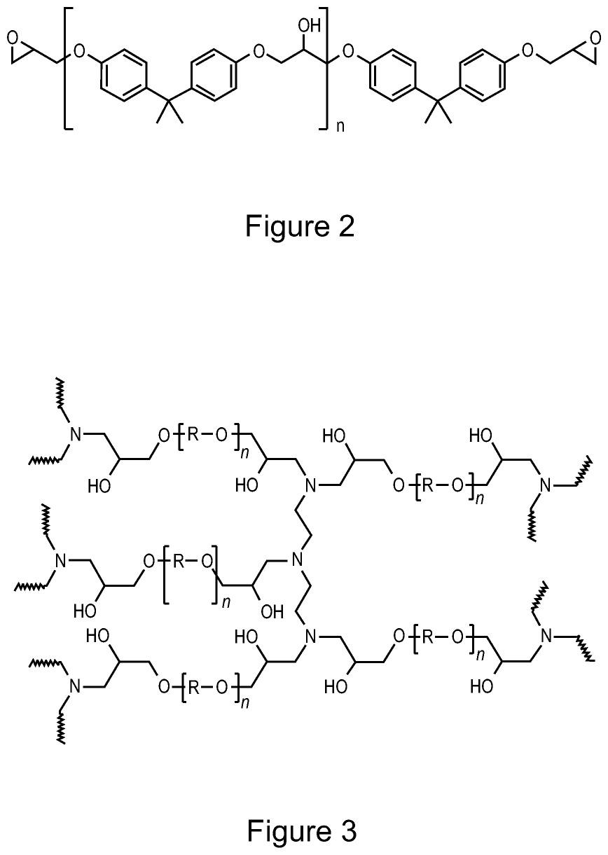

As used herein, a derivative of an epoxy resin refers to a monomer or polymer derived from an epoxy resin wherein a ring of the glycidyl ether has opened. FIG. 2 is an example of a derivative of an epoxy resin containing bisphenol A and an aliphatic monoglycidyl ether.

FIG. 3 is an example chemical structure of the aliphatic epoxy resin crosslinked polymers 2100. The R groups are the derivatives of the first epoxy resin (e.g., bisphenol A) and/or the derivative of the second epoxy resin (e.g., C₁₂-C₁₄ alkyl).

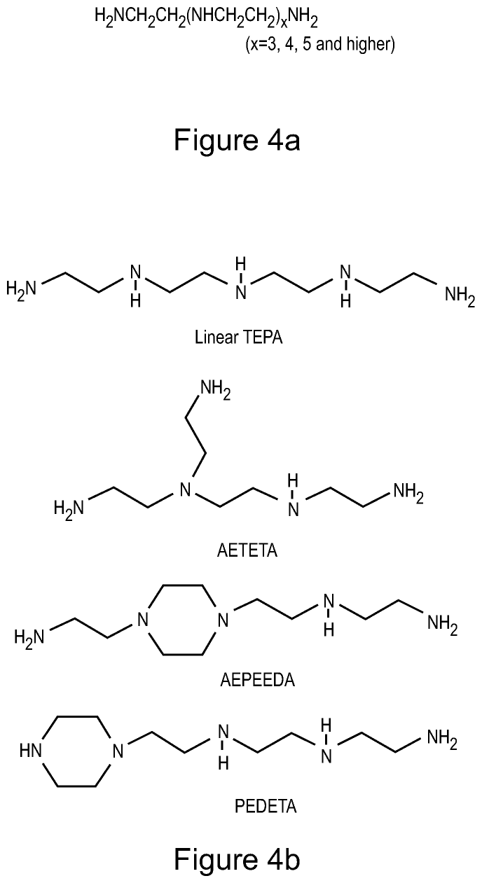

FIGS. 4a and 4b show examples of the polyamine that can be used in the mixture to form the aliphatic epoxy resin crosslinked polymers 2100. Examples of polyamines include linear, cyclic and branched products of tetraethylenepentamine (TEPA). Specific examples of polyamines include diethylenetriamine, tetraethylenepentamine, N¹,N¹′-(ethane-1,2-diyl)bis(N²-(2-aminoethyl)ethane-1,2-diamine), N¹-(2-aminoethyl)-N²-(2-((2-((2-((2-aminoethyl)amino)ethyl)amino)ethyl)amino)ethyl)ethane-1,2-diamine, N¹,N¹,N²-tris(2-aminoethyl)ethane-1,2-diamine, N¹-(2-(4-(2-aminoethyl)piperazin-1-yl)ethyl)ethane-1,2-diamine, and/or N¹-(2-aminoethyl)-N²-(2-(piperazin-1-yl)ethyl)ethane-1,2-diamine. Without wishing to be bound by theory, it is believed that the polyamine can serve as a crosslinker to crosslink polymers formed by the epoxy resins.

In some embodiments, the amount of the first epoxy resin (e.g., bisphenol A and an aliphatic monoglycidyl ether) is at least 0.5 (e.g., at least 1, at least 5, at least 10) weight percent (w.t. %) and at most 99.5 (e.g., at most 99, at most 95, 90) w.t. % in the mixture. In some embodiments, the amount of the first epoxy resin is 82 w.t. % In some embodiments, the amount of the second epoxy resin (e.g., C₁₂-C₁₄ alkyl glycidyl ether) is at least 0.5 (e.g., at least 1, at least 5, at least 10) weight percent (w.t. %) and at most 99.5 (e.g., at most 99, at most 95, at most 90) w.t. % in the mixture. In some embodiments, the amount of the second epoxy resin is 15 w.t. %. In some embodiments, the amount of the polyamine in the mixture is at least 0.5 (e.g. at least 1, at least 5, at least 10) and at most 50 (e.g. at most 49.5, at most 45, at most 40) in the mixture. In some embodiments, the amount of polyamine is 3 w.t. % in the mixture.

Without wishing to be bound by theory, it is believed that increasing the amount of polyamine decreases the amount of time for setting. Without wishing to be bound by theory, it is believed that the density of the epoxy resin crosslinked polymers can be altered by the amount of epoxy resin and crosslinker (i.e. polyamine) used in the mixture. In certain embodiments, manganese tetroxide (Mn₃O₄) and/or barite can be added to the mixture. Without wishing to be bound by theory, it is believed that the manganese tetroxide and/or barite can alter the density of the aliphatic epoxy resin crosslinked polymers. In certain embodiments, the amount of manganese tetroxide and/or barite is at least 1 (e.g., at least 2, at least 5) weight percent (w.t. %) and at most 50 (e.g., at most 49%, at most 45%) in the mixture.

In certain embodiments, the epoxy resin crosslinked polymers have a density of at least 62 (e.g. at least 62.5, at least 63, at least 63.5, at least 64) pound-force per cubic foot (pcf) of at least 160 (e.g. at least 150, at least 140, at least 130, at least 120, at least 110, at least 100, at least 68, at least 67.5, at least 67, at least 66.5, at least 66) pcf.

In some embodiments, the mixture has a thickening time of at least 3 (e.g., at least 3.5, at least 4, at least 4.5, at least 5) hours and at most 9 (e.g. at most 8.5, at most 8, at most 7.5 at most 7) hours to form the epoxy resin crosslinked polymers.

In some embodiments, the epoxy resin crosslinked polymers have a consistency of at least 10 (e.g. at least 12, at least 20, at least 30, at least 40, at least 50, at least 60) Bearden Consistency units (Bc.) and at most 100 (e.g., at most 90, at most 80) Bc. after a time of at least 3 (e.g. at least 3.5, at least 4, at least 4.5, at least 5, at least 5.5, at least 6, at least 6.5, at least 7, at least 7.5, at least 8, at least 8.5) hours.

In some embodiments, the epoxy resin crosslinked polymers have a compressive strength of at least 100 (e.g., at least 1,000, at least 5,000, at least 10,000) pound of force (psi) and at most 20,000 (e.g. at most 19,000, at most 18,000, at most 17,000, at most 16,000, at most 20,000) psi.

### EXAMPLES

### Example 1

Seven formulations with the compositions show in table 1 were prepared. For all formulations, Resin 1 was Razeen LR 2254 epoxy resin (epoxy resin based on bisphenol A and modified with an aliphatic monoglycidyl ether) (Jana Chemicals) and Resin 2 was Razeen D 7106 epoxy resin (C₁₂-C₁₄ alkyl glycidyl ether) (Jana Chemicals). For formulations 1 and 3-6, the cross linker was Razeencure 931 (diethylenetriamine) curing agent (Jana Chemicals). For formulations 2 and 7, the cross linker was tetraethylenepentamine (TEPA) (Arabian Amines Company). Manganese tetroxide (Mn₃O₄) (Elkem) was used in formulations 5-7. The ingredients were combined in a standard API blender and blended with a rotational speed of 12,000 rotations per minute (RPM) (API Recommended Practice 10B-2, Second Edition, April 2013)

TABLE 1
Composition of Formulations

| | Resin | Resin | Cross | |
|---|---|---|---|---|
| Formulation | 1 (g) | 2 (g) | linker* (g) | Mn₃O₄ (g) |
| 1 | 480 | 120 | 18 | — |
| 2 | 510 | 90 | 18 | — |
| 3 | 510 | 90 | 16.8 | — |
| 4 | 510 | 90 | 18 | — |
| 5 | 510 | 90 | 18 | 7 |
| 6 | 510 | 90 | 18 | 28 |
| 7 | 510 | 90 | 18 | 28 |

*Cross linker of formulations 1 and 3-6: diethylenetriamine; cross linker for formulations 2 and 7: tetraethylenepentamine (TEPA).

### Example 2—Thickening Time Test

Each prepared formulation was poured into an API standard HPHT consistometer slurry cup to evaluate the pumpability of the formulation. A resistor arm on a potentiometer indicated resistance to paddle turning as the formulation set. The thickening time test was performed at a temperature of 299° F. and pressure of 3000 psi to simulate pumping (API Recommended Practice 10B-2, Second Edition, April 2013, page 35). The apparatus was calibrated to Bearden Consistency units. Bearden consistency units express consistency of a cement slurry when determined on a pressurized consistometer and are related to poise (N s/m²). Generally, a thickening time of 9 Bearden Consistency units (Bc.) after 4.5 hours corresponds to a liquid. The Bearden Consistency units scales from 1 to 100. Difficultly pumping is expected to begin at 50 Bc. and complete setting occurs at 100 Bc. Observation of a straight flat line in a consistency over time measurement (i.e., constant consistency over time) indicates a liquid. The consistency was determined using the equation:

T=78.2+20.02B_{c},

where T is the torque in gram-centimeters (g·cm) and B_{c} is the consistency in Bearden units.

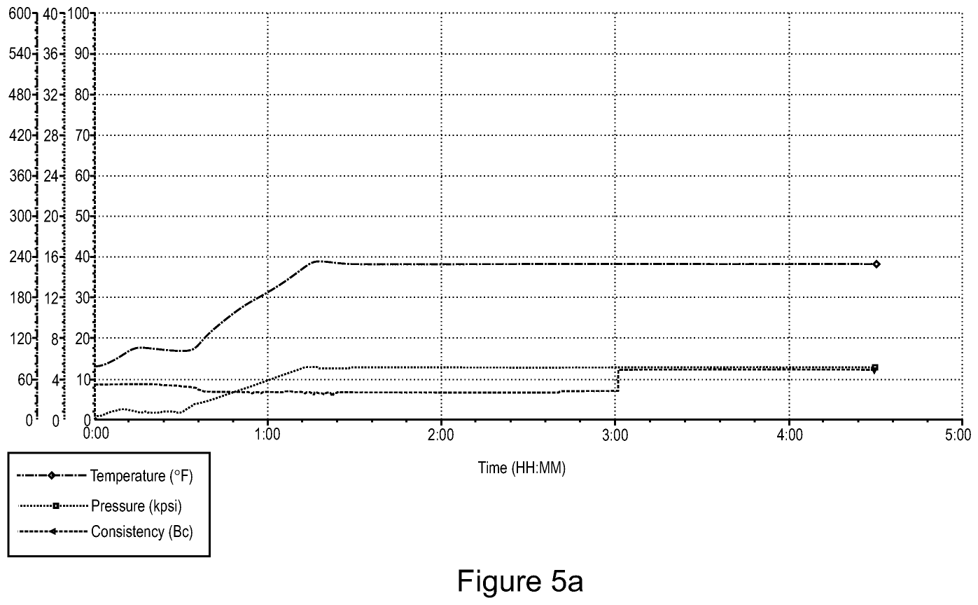

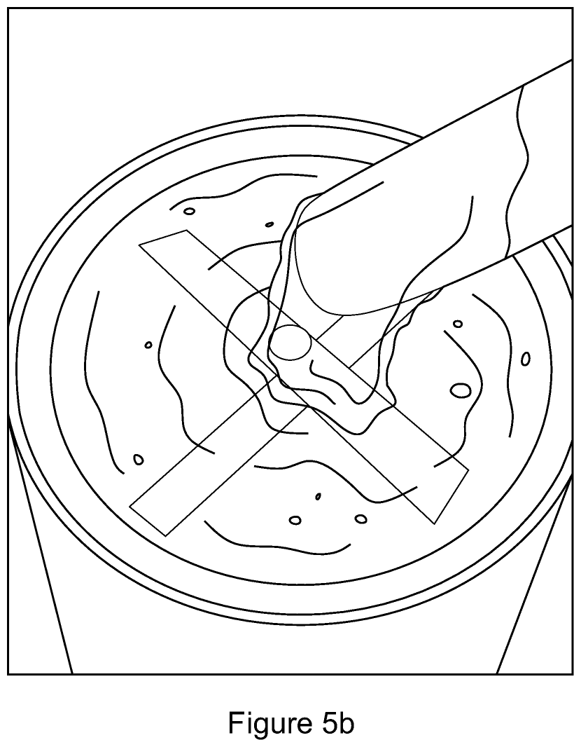

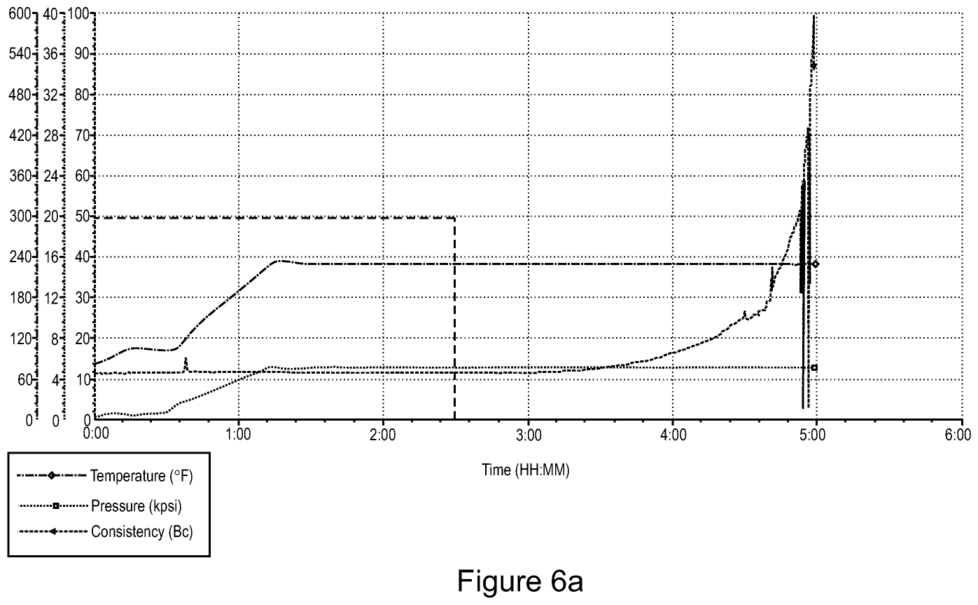

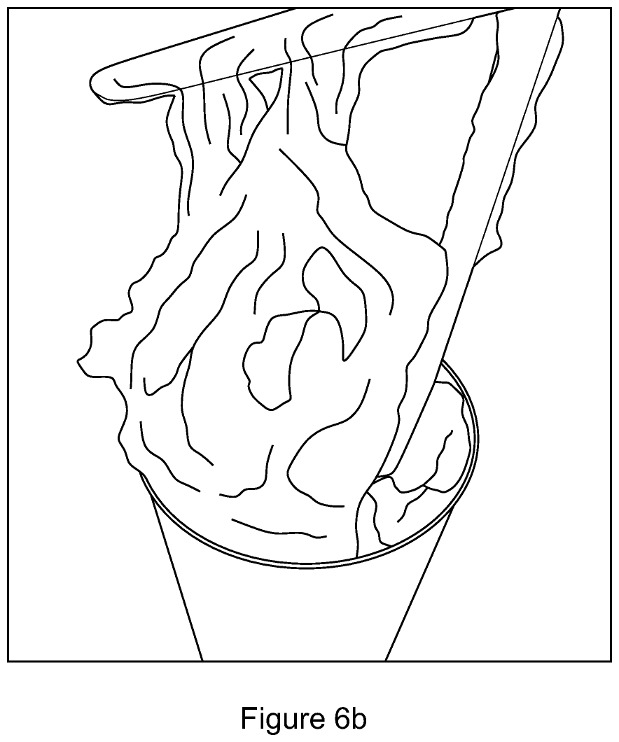

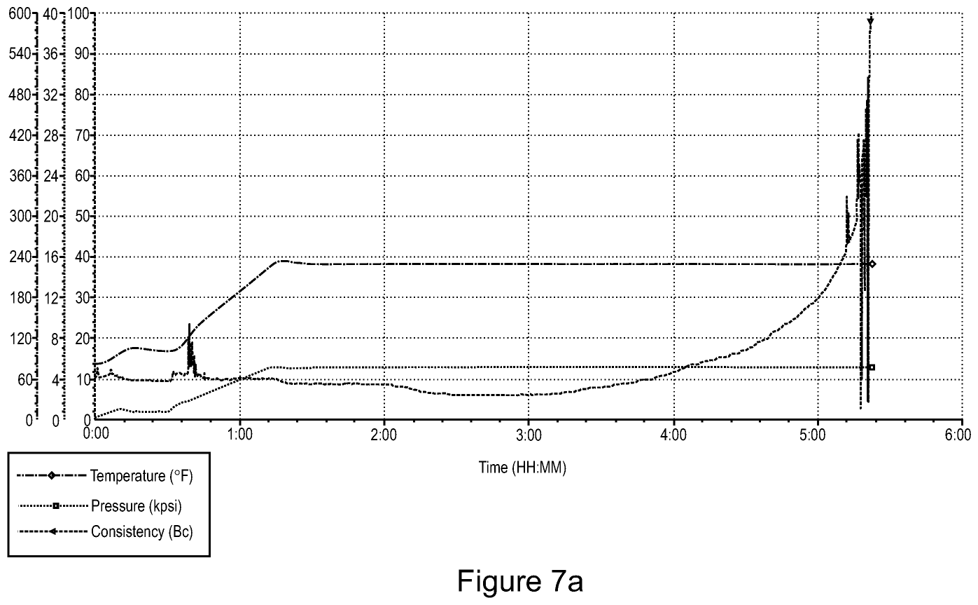

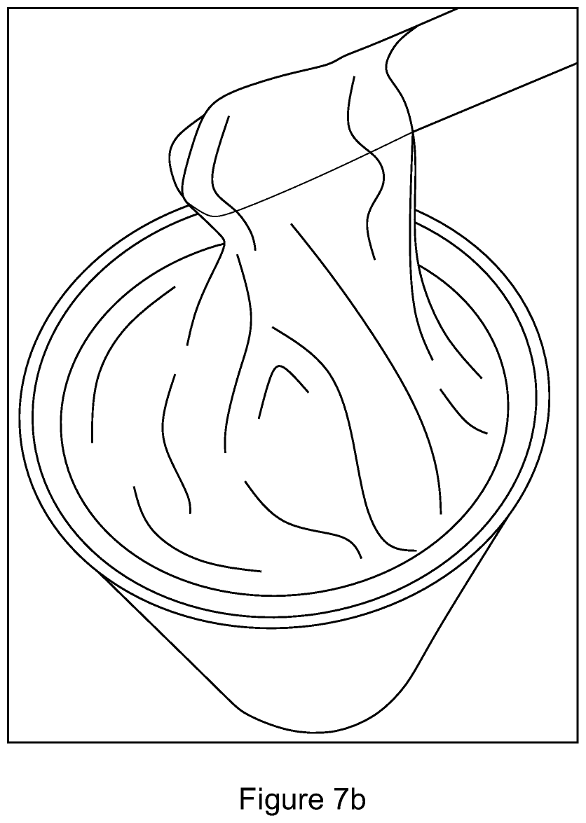

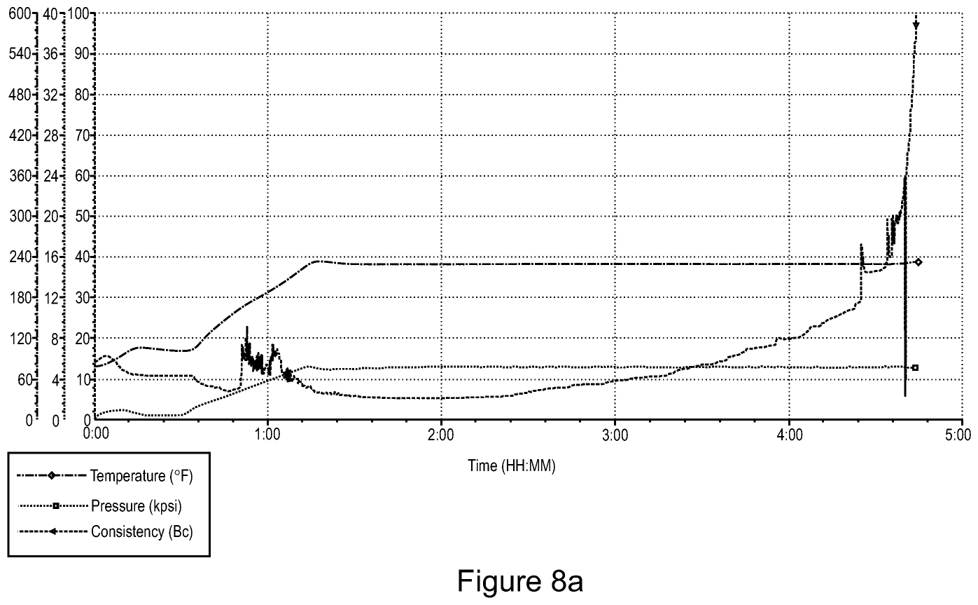

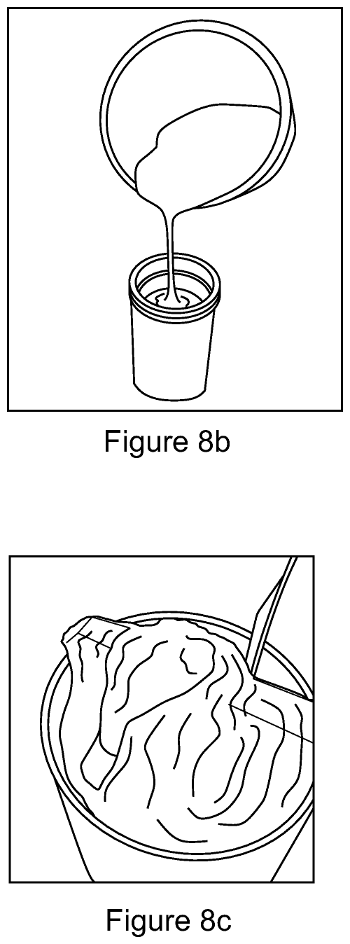

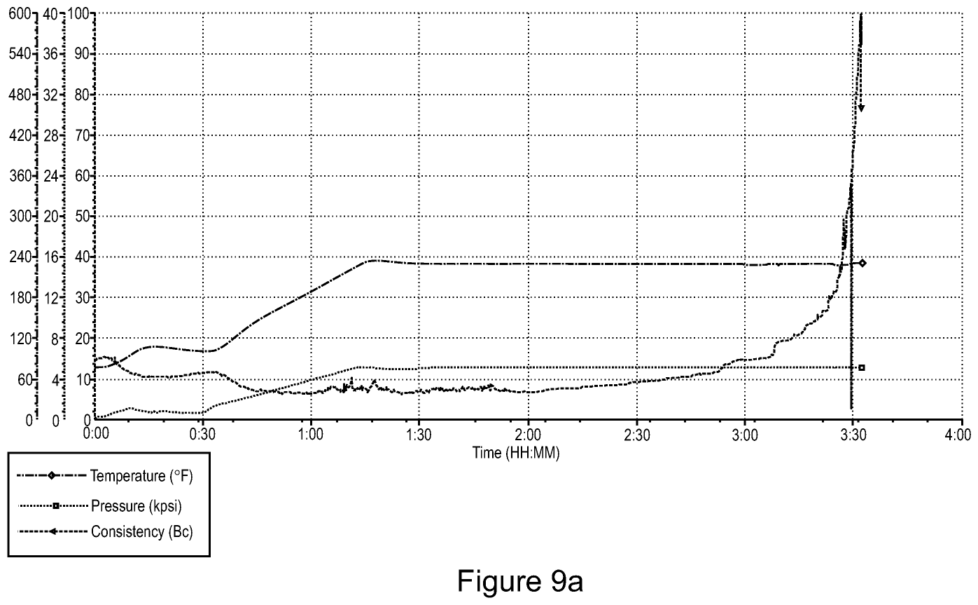

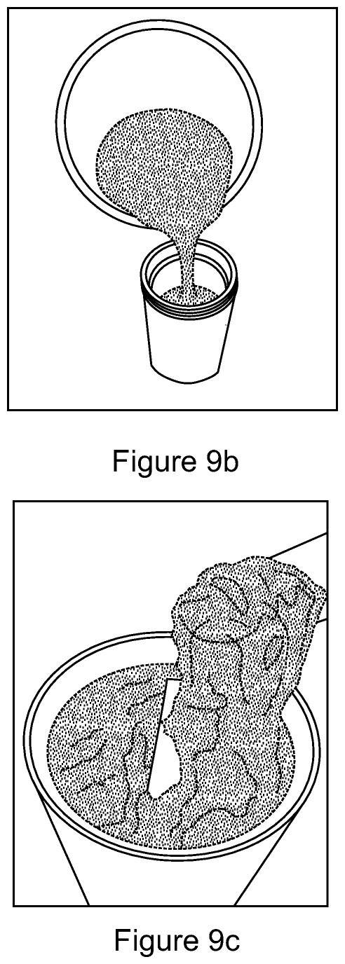

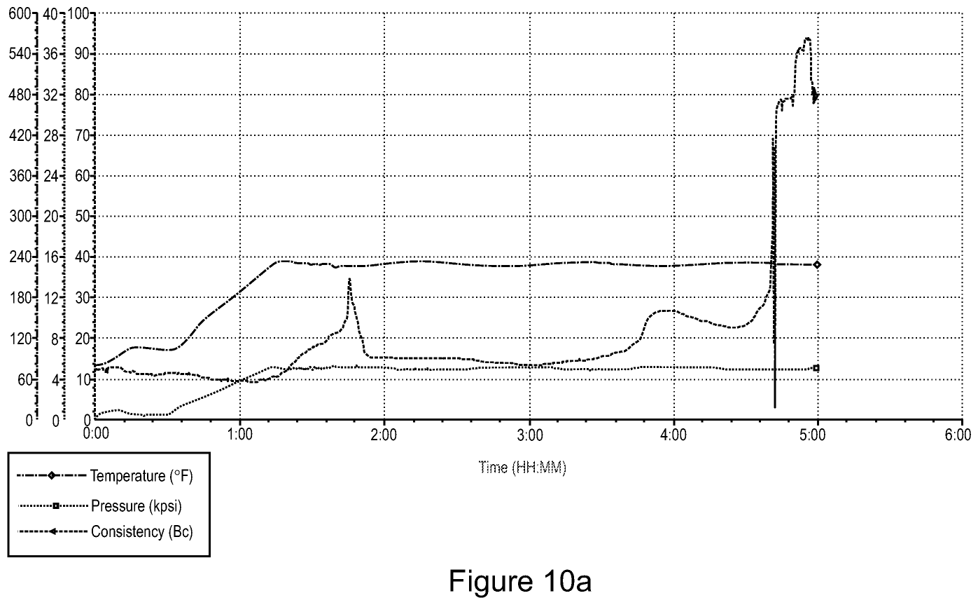

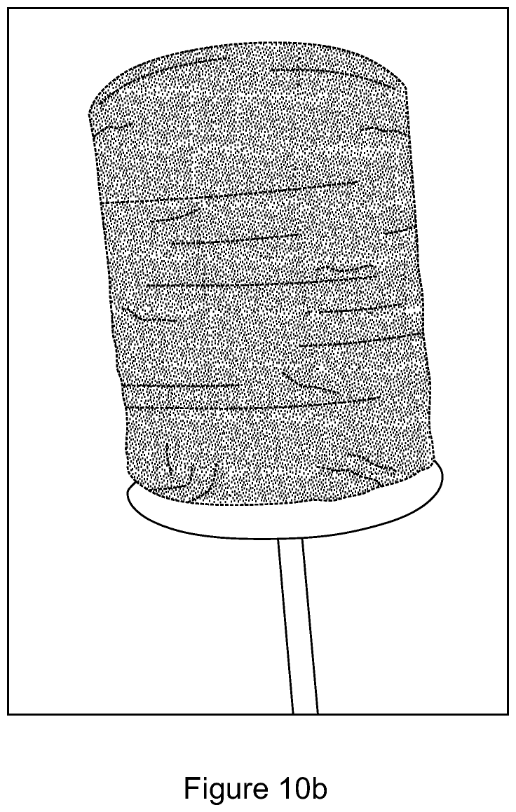

The consistency over time of formulations 1-6 are shown in FIGS. 5a, 6a, 7a, 8a, 9a and 10a, respectively. Illustrations of formulations 1, 2, 3 and 6 after the thickening time test are shown in FIGS. 5b, 6b, 7b and 10b, respectively. Illustrations of formulations 4 and 5 before the thickening time test are shown in FIGS. 8b and 9b and after the thickening time test are shown in FIGS. 8c and 9c. The formulations shown in FIGS. 9b and 9c were brown.

Densities were measured using a pressurized fluid density balance (API Recommended Practice 10B-2, Second Edition, April 2013). The sample cup was pressurized to decrease the volume of air to a negligible volume to provide more accurate density measurements of the samples.

The densities and thickening time for each formulation are presented in table 2.

TABLE 2
Densities and Thickening Times of Formulations

| Formulation | Density (pcf) | Thickening time |
|---|---|---|
| 1 | 62.5 | 12 Bc. at 3 hrs. and 32 min. |
| 2 | 65.5 | 100 Bc. at 4 hrs. and 59 min. |
| 3 | 65.5 | 100 Bc. at 5 hrs. and 22 min. |
| 4 | 65.5 | 100 Bc. At 4 hrs. and 45 min. |
| 5 | 68 | 100 Bc. at 3 hrs. and 32 min. |
| 6 | 68 | 14 Bc. At 8 hours and 25 min. |
| 7 | 68 | 91 c. at 5 hours |

Formulations 1 and 2, using diethylenetriamine and TEPA crosslinkers respectively, both had acceptable thickening time values (between 2-10 hours) as they would remain in the liquid phase until pumping is complete. Changing the concentrations of crosslinker and epoxy resins resulted in different thickening times, as observed in formulations 3 and 4. Formulation 5 showed that the use of manganese tetroxide increased the density to 68 pcf relative to formulations 1-4. Formulation 5 also had a short thickening time. Increasing the amount of manganese tetroxide in formulation 6 relative to formulation 5 increased the thickening time. The consistency of formulation 6 was 14 Bc. at 8 hours and 25 minutes, indicating that the formulation was still a liquid. Formulation 7, which used TEPA, had a consistency of 91 Bc. after 5 hours.

### Example 3—Curing at Down-Hole Conditions

A HPHT curing chamber was used for curing the formulations at elevated temperatures and pressure to simulate well conditions. Formulations 2, 6 and 7 were poured into standard API compressive strength 2″×2″×2″ cubical molds (API Recommended Practice 10B-2, Second Edition, April 2013). The curing chamber was filled with water to expel gas. A temperature controller was used to regulate the sample temperature. A pressure of 3000 psi and a temperature of 229° F. were maintained for the duration of the curing. The pressure and temperature were then reduced too ambient conditions and the sample was removed from the curing chamber.

### Example 4—Compressive Strength Test

Set cubes of formulation 2, 6, and 7 prepared as described in Example 4 were removed from the molds and placed in a hydraulic press, which applied known compressive loads on the samples. Increasing force was exerted on each end of the sample until failure (the cube was destroyed). The system tested the compressive strength of the cubes in compliance with API specifications for oil well cement testing (API Recommended Practice 10B-2, Second Edition, April 2013).

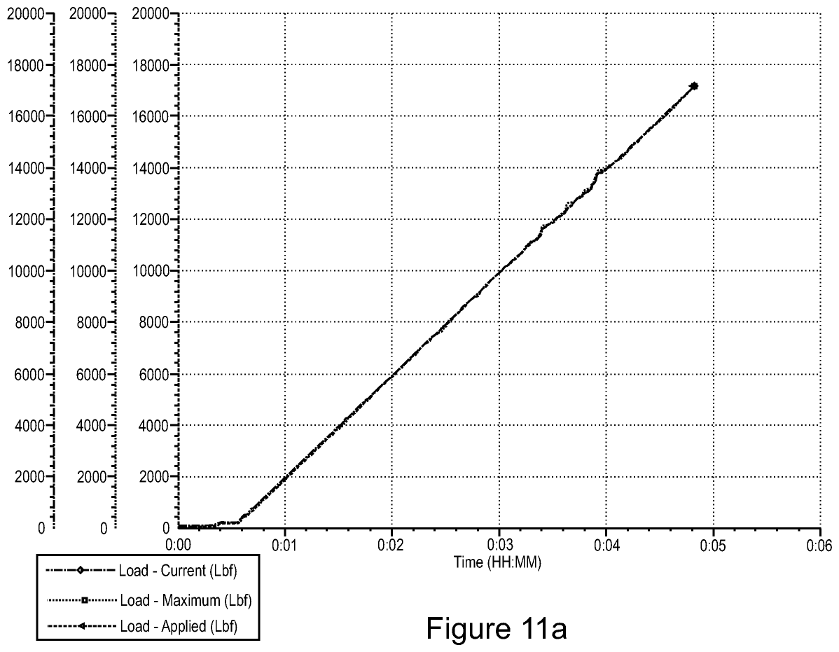

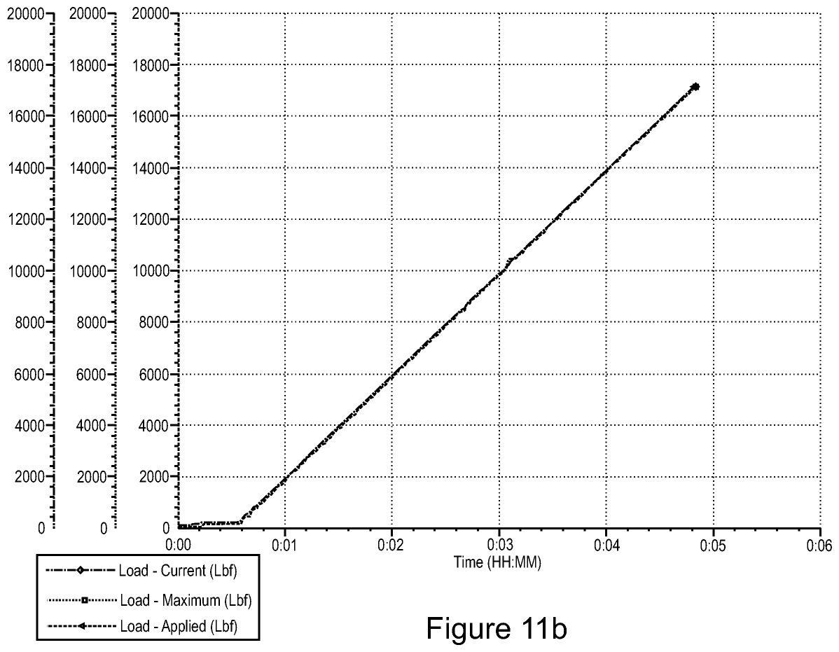

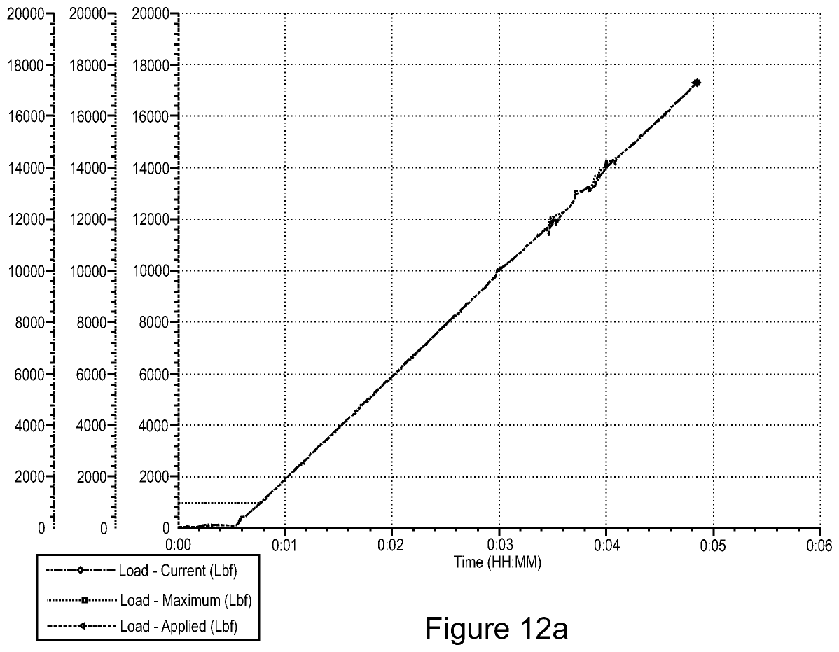

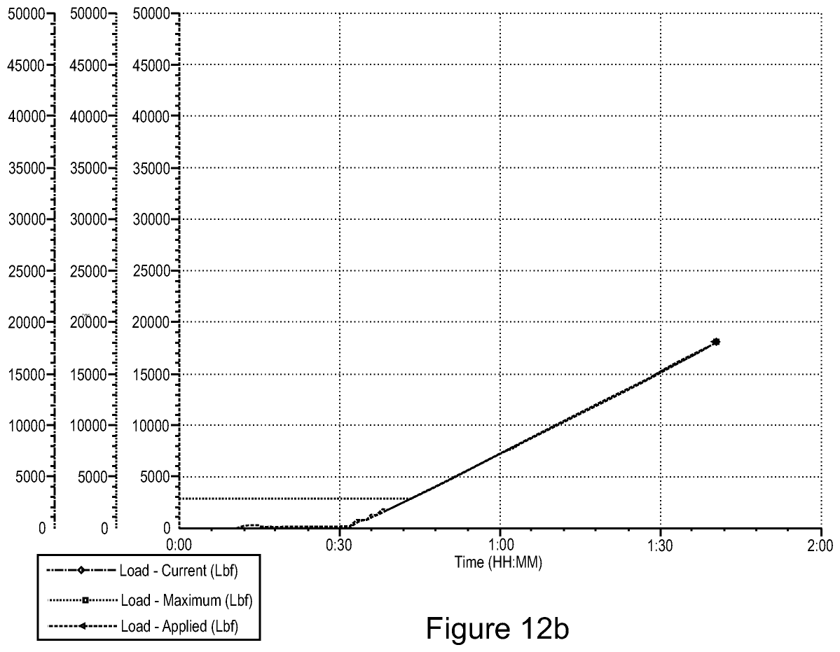

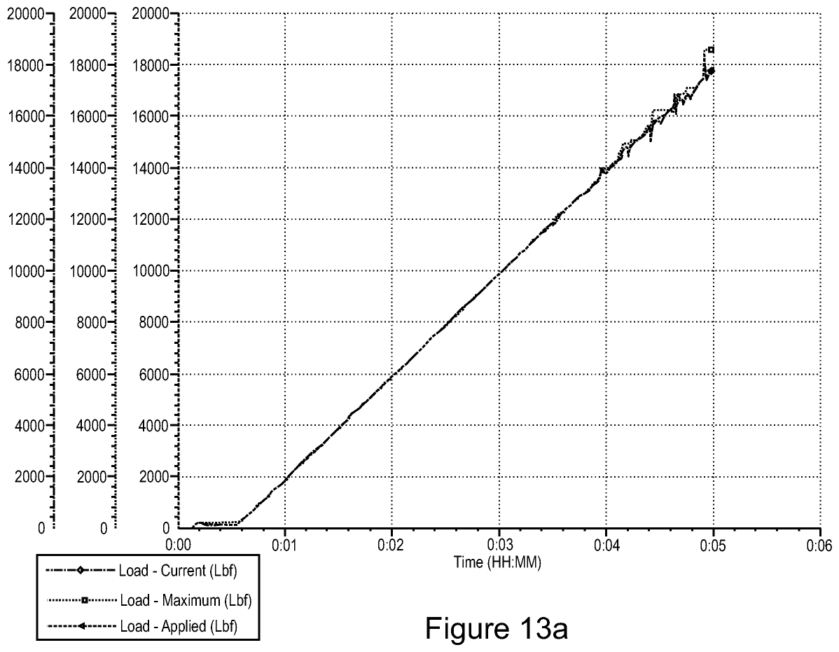

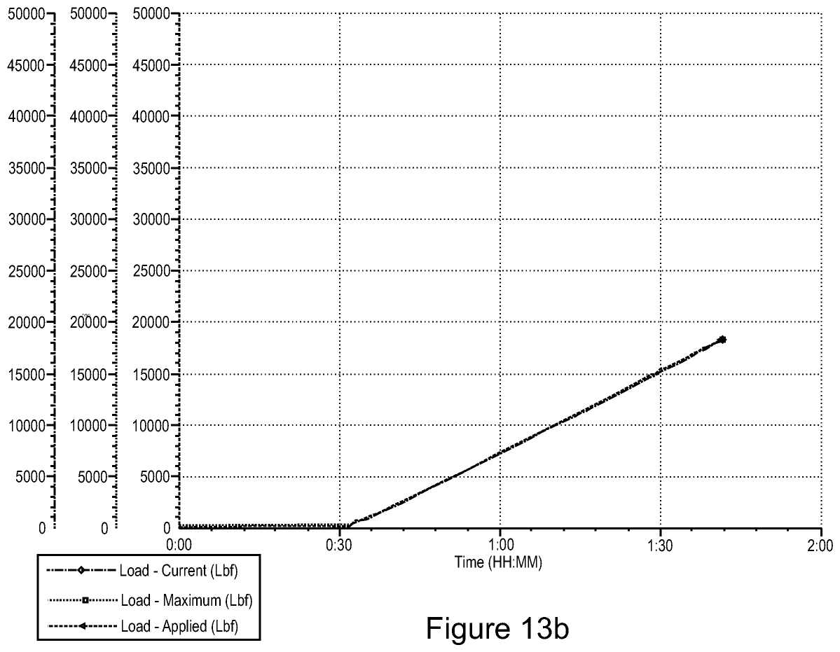

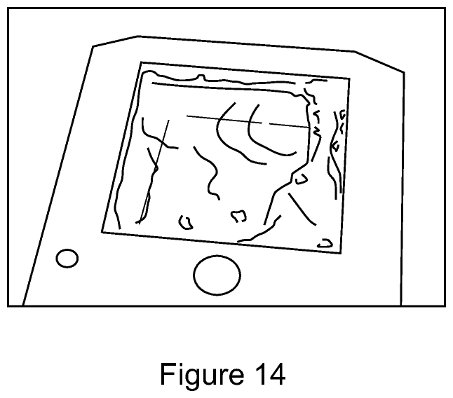

Loads of over 17,000 pound-force (lbf) was applied without breaking the samples. Tests were suspended after 17,000 lbf to avoid damaging the equipment. Compressive strength measurements on cubes of formula 7 are shown in FIGS. 11a and 11b. Compressive strength measurements on cubes of formula 2 are shown in FIGS. 12a and 12b. Compressive strength measurements on cubes of formula 6 are shown in FIGS. 13a and 13b. FIG. 14 shows an illustration of a cube of formula 6 after curing.

1. A method, comprising adding a mixture consisting essentially of a first epoxy resin, a second epoxy resin and a polyamine to an annular space formed by a casing and a borehole;
wherein the mixture forms epoxy resin crosslinked polymers comprising a derivative of the first epoxy resin, a derivative of the second epoxy resin and the polyamine in the annular space;
wherein the first epoxy resin comprises bisphenol A and an aliphatic monoglycidyl ether; and
wherein the second epoxy resin comprises a C₁₂-C₁₄ alkyl glycidyl ether.

2. The method of claim 1, wherein the polyamine comprises a member selected from the group consisting of diethylenetriamine, tetraethylenepentamine, a linear derivative of diethylenetriamine, a branched derivative of diethylenetriamine, and a derivative of diethylenetriamine comprising at least one ring.

3. The method of claim 2, wherein the polyamine comprises a member selected from the group consisting of diethylenetriamine, tetraethylenepentamine, N¹,N¹′-(ethane-1,2-diyl)bis(N²-(2-aminoethyl)ethane-1,2-diamine), N¹-(2-aminoethyl)-N²-(2-((2-((2-((2-aminoethyl)amino)ethyl)amino)ethyl)amino)ethyl)ethane-1,2-diamine, N¹,N¹,N²-tris(2-aminoethyl)ethane-1,2-diamine, N¹-(2-(4-(2-aminoethyl)piperazin-1-yl)ethyl)ethane-1,2-diamine, and N¹-(2-aminoethyl)-N²-(2-(piperazin-1-yl)ethyl)ethane-1,2-diamine.

4. The method of claim 1, wherein the mixture comprises a weight percent (w.t. %) of the first epoxy resin of 76 w.t. % to 83 w.t. %.

5. The method of claim 1, wherein the mixture comprises a weight percent of the second epoxy resin of 12 w.t. % to 20 w.t. %.

6. The method of claim 1, wherein the mixture comprises a weight percent of the polyamine of 2 w.t. % to 3 w.t. %.

7. (canceled)

8. (canceled)

9. The method of claim 1, wherein a thickening time of the mixture is from 3.5 hours to 8.5 hours.

10. The method of claim 1, wherein the epoxy resin crosslinked polymers have a density of 62.5 pound-force per cubic foot (pcf) to 68 pcf.

11. The method of claim 1, wherein the resin epoxy resin crosslinked polymers have a compressive strength of 1,000 pound-force (lbf) to 20,000 lbf.

12. The method of claim 1, wherein the epoxy resin crosslinked polymers have a consistency of from 12 Bearden Consistency units (Bc.) to 100 Bc. after a time of at least 8.5 hours after forming the mixture.

13. (canceled)

14. The method of claim 1, wherein the mixture is used in a primary cementing application.

15.-20. (canceled)

21. A method, comprising adding a mixture consisting essentially of a first epoxy resin, a second epoxy resin, manganese tetroxide, and a polyamine to an annular space formed by a casing and a borehole;
wherein the mixture forms epoxy resin crosslinked polymers comprising a derivative of the first epoxy resin, a derivative of the second epoxy resin and the polyamine in the annular space;
wherein the first epoxy resin comprises bisphenol A and an aliphatic monoglycidyl ether; and
wherein the second epoxy resin comprises a C₁₂-C₁₄ alkyl glycidyl ether.

22. The method of claim 21, wherein mixture comprises a weight percent of manganese tetroxide of 1 w.t. % to 5 w.t. %.

23. The method of claim 21, wherein the mixture comprises a weight percent (w.t. %) of the first epoxy resin of 76 w.t. % to 83 w.t. %.

24. The method of claim 21, wherein the mixture comprises a weight percent of the second epoxy resin of 12 w.t. % to 20 w.t. %.

25. The method of claim 21, wherein the mixture comprises a weight percent of the polyamine of 2 w.t. % to 3 w.t. %.

26. A method, comprising adding a mixture consisting essentially of a first epoxy resin, a second epoxy resin, barite and a polyamine to an annular space formed by a casing and a borehole;
wherein the mixture forms epoxy resin crosslinked polymers comprising a derivative of the first epoxy resin, a derivative of the second epoxy resin and the polyamine in the annular space;
wherein the first epoxy resin comprises bisphenol A and an aliphatic monoglycidyl ether; and
wherein the second epoxy resin comprises a C₁₂-C₁₄ alkyl glycidyl ether.

27. The method of claim 26, wherein the mixture comprises a weight percent (w.t. %) of the first epoxy resin of 76 w.t. % to 83 w.t. %.

28. The method of claim 26, wherein the mixture comprises a weight percent of the second epoxy resin of 12 w.t. % to 20 w.t. %.

29. The method of claim 26, wherein the mixture comprises a weight percent of the polyamine of 2 w.t. % to 3 w.t. %.
